(19) United States
(12) Patent Application Publication
(10) Pub. No.: US 2017/0257932 A1
(43) Pub. Date: Sep. 7, 2017

(54) LED Driving System with Power Transmission Path Coincided with Data Transmission Path

(71) Applicant: DONGGUAN CITY MINLEON ELECTRONICS CO., LTD., GUANGDONG (CN)

(72) Inventors: Fengcheng LIN, GUANGDONG (CN); Wangrui GUO, GUANGDONG (CN); Hao LIN, GUANGDONG (CN)

(21) Appl. No.: 15/444,346

(22) Filed: Feb. 28, 2017

(30) Foreign Application Priority Data
Mar. 3, 2016 (CN) 201610119984.4

(51) Int. Cl. H05B 37/02; H05B 33/08

(52) U.S. Cl. CPC H05B 37/0263; H05B 33/0857

(57) ABSTRACT

An LED driving system with power transmission path coincided with data transmission path, having a plurality of LED driving chips, each having a main input end, a main output end, a logic control module, an RGB gray adjustment module, a power supply module, a voltage clamping module, a digital signal extraction module and a signal processing module. The input end of the voltage clamping module is connected with the main output end of the previous LED driving chip, the output end is connected with the main input end of the next LED driving chip The main input end of the LED driving chip is connected with the digital signal extraction module, which then connects with the signal processing module whose output end is connected with the logic control module which has an output end connected with the RGB gray adjustment module.

### BACKGROUND OF THE INVENTION

The invention relates to the technical field of LED driving, in particular to an LED driving system with power transmission path coincided with data transmission path.

In the prior art of application of decorative lights, flexible and hard light bars, LED driving chips are connected in parallel. The chips of all levels are connected in parallel on the same power cord. In this way, the whole system may load with overlarge current, thus making thickness of FPC copper foil increase to some extent and cost of LED products rise.

### BRIEF SUMMARY OF THE INVENTION

The present invention aims at solving the technical problem of providing an LED driving system that can reduce its current, simplify its wiring, decrease thickness of the FPC copper foil, and save product cost.

The technical scheme of the present invention for solving the aforementioned problem provides an LED driving system with power transmission path coincided with data transmission path, comprising a plurality of LED driving chips, each of which comprises a main input end, a main output end, a logic control module, an RGB gray adjustment module, a power supply module, a voltage clamping module, a digital signal extraction module and a signal processing module. The LED driving chip also comprises:

a voltage clamping module used for clamping voltage of the LED driving chips within the preset range;

a digital signal extraction module used for extracting Manchester codes containing RGB gray data and outputting corresponding signals;

a signal processing module used for receiving extraction signals and acquiring valid data of the corresponding position according to the addresses stored in the current LED driving chips, and outputting the valid data to the logic control module in such a way that the logic control module can control the RGB gray adjustment module to adjust RGB grayscale according to the valid data.

Among them, the input end of the voltage clamping module is connected with the main output end of the previous LED driving chip through the main input end, and the output end is connected with the main input end of the next LED driving chip through the main output end; the power supply module is connected with the main input end of the LED driving chip and supplies power for it; the input end of the digital signal extraction module is connected with the main input end of the LED driving chip, and the output end thereof is connected with the input end of the signal processing module; the output end of the signal processing module is connected with the input end of the logic control module; the output end of the logic control module is connected with the controlled end of the RGB gray adjustment module.

Preferably, each of the LED driving chips also comprises a reference voltage generation module used for generating reference voltage, and a comparison module, wherein the reference voltage output end of the reference voltage generation module is connected with the reference voltage input end of the comparison module, the comparison voltage input end of the comparison module is connected with the main input end of the LED driving chips, and the comparison result output end of the comparison module is connected with the controlled end of the power supply module so as to control the power supply module to be on or off.

Preferably, each of the LED driving chips also comprises a storage module used for storing calibration value of the reference voltage and the addresses of the LED driving chips, and the reference voltage calibration value output end of the storage module is connected with the reference voltage input end of the comparison module.

Preferably, each of the LED driving chips also comprises a filter module used for filtering clutter signals of the power supply. The filter module is arranged between the main input end and the power supply module.

Preferably, the LED driving system also comprises a relay used for compensating voltage, and the relay is arranged among the serially connected LED driving chips so as to lengthen the serial connection line.

The LED driving system with power transmission path coincided with data transmission path of the present invention comprises a plurality of LED driving chips, which are serially connected. Particularly, the power transmission path of each LED driving chip is coincided with its path transmission path. The main input end of the LED driving chip is connected with the main output end of the previous LED driving chip, and the main output end of the LED driving chip is connected with the main input end of the next LED driving chip. The voltage clamping module inlaid in the LED driving chip makes sure stability of the voltage. The power transmission path is coincided with data transmission path, thus further simplifying wiring of the LED driving system. The digital signal extraction module is connected with the main input end of the LED driving chip and extracts Manchester code from the main input end as extraction signals output to the signal processing module. The signal processing module is in charge of acquiring valid data corresponding to the address of the LED driving chip from the extraction signals and transmitting the valid data to the logic control module. The logic control module outputs corresponding control signals to the RGB gray control module according to the received valid data, so as to adjust pulse width of PWM signals output by the RGB gray control module for realizing the purpose of RGB grayscale adjustment. The LED driving chips in the LED driving system that are connected in series overcome the defects of overlarge current and overlarge FPC copper foil thickness and the resultant increase of the product cost due to the parallel connection of the prior art. In the invention, the LED driving chips of each node are same in current, the thickness of FPC thickness is significantly lowered, and resultantly the cost of the whole product is saved by 50-60% as well. On the other hand, coincidence of the power transmission path and the data transmission path simplifies wiring of the system and reduces wiring cost of the product as well.

### BRIEF DESCRIPTION OF THE DRAWINGS

FIG. 1 is a module chart of the LED driving system with the power transmission path coincided with the data transmission path;

FIG. 2 is a module chart of the first embodiment of the LED driving chips of the LED driving system with the power transmission path coincided with the data transmission path;

FIG. 3 is a module charge of the second embodiment of the LED driving chips of the LED driving system with the power transmission path coincided with the data transmission path;

FIG. 4 is a module charge of the third embodiment of the LED driving chips of the LED driving system with the power transmission path coincided with the data transmission path;

FIG. 5 is a module charge of the third embodiment of the LED driving chips of the LED driving system with the power transmission path coincided with the data transmission path.

The objects, features and advantages of the present invention will be described in further detail with reference to the accompanying drawings.

### DETAILED DESCRIPTION OF THE INVENTION

The present invention will now be described in further detail with specific embodiments with reference to the accompanying drawings.

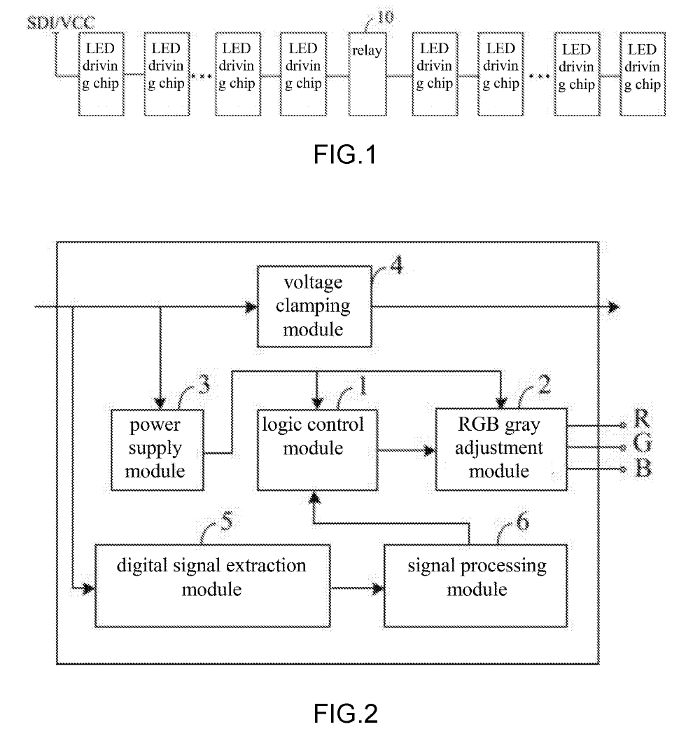

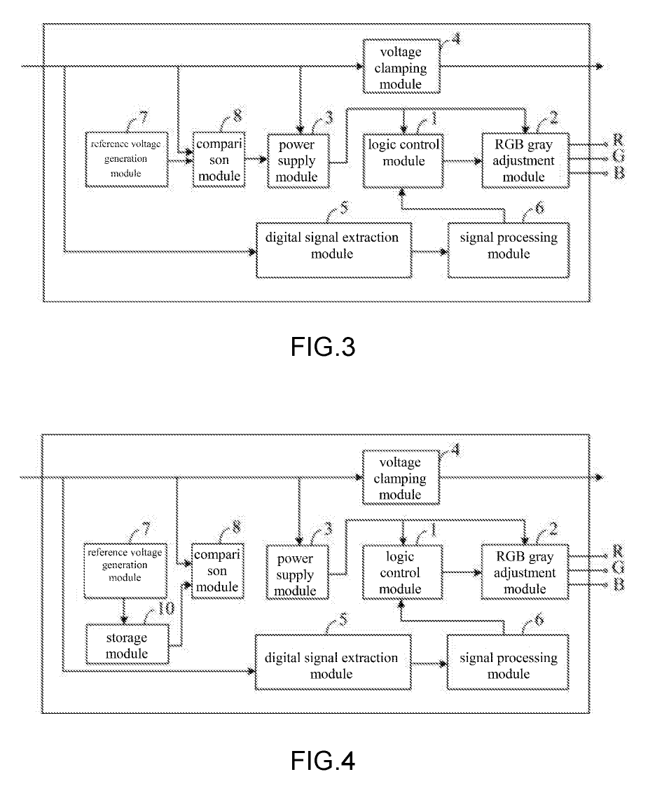

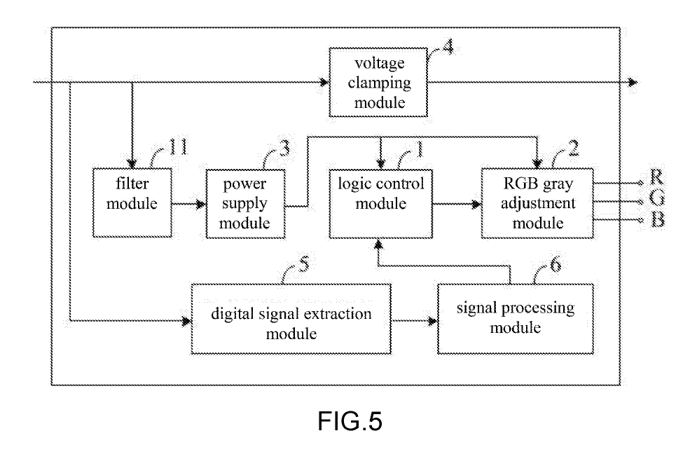

With reference to FIG. 1 to 5, FIG. 1 is a module chart of the LED driving system with the power transmission path coincided with the data transmission path; FIG. 2 is a module chart of the first embodiment of the LED driving chips of the LED driving system with the power transmission path coincided with the data transmission path; FIG. 3 is a module charge of the second embodiment of the LED driving chips of the LED driving system with the power transmission path coincided with the data transmission path; FIG. 4 is a module charge of the third embodiment of the LED driving chips of the LED driving system with the power transmission path coincided with the data transmission path; FIG. 5 is a module charge of the third embodiment of the LED driving chips of the LED driving system with the power transmission path coincided with the data transmission path. In one embodiment, the LED driving system with power transmission path coincided with data transmission path of the present invention comprises a plurality of LED driving chips, which are serially connected.

Each of the LED driving chips comprises a main input end, a main output end, a logic control module 1, an RGB gray adjustment module 2, a power supply module 3, a voltage clamping module 4, a digital signal extraction module 5 and a signal processing module 6. The input end of the voltage clamping module 4 is connected with the main output end of the previous LED driving chip through the main input end of the LED driving chip, and the output end thereof is connected with the main input end of the next LED driving chip through the main output end of the LED driving chip. The power supply module 3 is connected with the main input end of the LED driving chip and supplies power for the same. The input end of the digital signal extraction module 5 is connected with the main input end of the LED driving chip, and the output end is connected with the input end of the signal processing module 6. The output end of the signal processing module 6 is connected with the input end of the logic control module 1, and the output end of the logic control module 1 is connected with the controlled end of the RGB gray adjustment module 2.

The voltage clamping module 4 is used for stabilizing power voltage of the LED driving chips. It should be noted that in order to avoid instable operation of the LED driving chips due to power supply fluctuation of the LED driving chips, in this embodiment, the voltage clamping module 4 clamps voltage within a fixed voltage range. In this way, the component voltage of the serially connected LED driving chips at each level is fixed, stable power supply of the LED driving chips is guaranteed, and the LED driving chips can be protected in case of overvoltage of the power supply. If the working voltage of the LED driving chips is 3.3V, the voltage clamping module 4 clamps the dropout voltage between the power input end and the power output end at 3.3V.

The digital signal extraction module 5 is used for extracting Manchester code from the main input end. It should be noted that the Manchester code contains control commands for adjusting RGB grayscale, and data of all chips are included in one frame of data of the Manchester code. Particularly, if the LED driving system comprises N chips, one frame of data will contain 3×N data. In details, one frame of data contains start+data1+data2+data3+ . . . +data (N−2)+data (N−1)+dataN+End, each chip extracts data from the designated position of this frame of data according to its own address. For example, the LED driving chip at the address 1 extracts data1+data2+data3; the LED driving chip at the address 5 extracts data13+data14+data15, and so on, and the data mismatched with the chip address are not extracted. Since the power transmission path of the LED driving chip coincides with the Manchester code transmission path, the digital signal module 5 extracts the Manchester code from the main input end and outputs the corresponding extraction signals to the signal processing module 6.

The signal processing module 6 receives extraction signals output by the digital signal extraction module 5. It should be noted that a unique address is burned in each LED driving chip. The signal processing module 6 receives extraction signals and acquires valid data segments (namely valid data) corresponding to the address of the LED driving chip from the extraction signals and transmits the valid data to the logic control module 1. The logic control module 1 outputs corresponding control signals to the RGB gray control module according to the received valid data, so as to adjust pulse width of PWM signals, control switching time of RGB, and finally adjust the RGB grayscale.

An OSC module (not shown) is inlaid in the LED driving chip and provides clock signals for the LED driving chip. Particularly, the OSC module is a ring oscillator used for generating clock signals for the logic control module 1, and clock signals after frequency division are used for RGB grayscale adjustment. In addition, an ISET module (not shown) is inlaid in the LED driving chip and used for generating 100% of current bias of RGB.

The LED driving system with power transmission path coincided with data transmission path of the present invention comprises a plurality of LED driving chips, which are serially connected. Particularly, the power transmission path of each LED driving chip is coincided with its path transmission path. The main input end of the LED driving chip is connected with the main output end of the previous LED driving chip, and the main output end of the LED driving chip is connected with the main input end of the next LED driving chip. The voltage clamping module 4 inlaid in the LED driving chip makes sure stability of the voltage. The power transmission path is coincided with data transmission path, thus further simplifying wiring of the LED driving system. The digital signal extraction module 5 is connected with the main input end of the LED driving chip and extracts Manchester code from the main input end as extraction signals output to the signal processing module 6. The signal processing module 6 is in charge of acquiring valid data corresponding to the address of the LED driving chip from the extraction signals and transmitting the valid data to the logic control module 1. The logic control module 1 outputs corresponding control signals to the RGB gray control module according to the received valid data, so as to adjust pulse width of PWM signals output by the RGB gray control module for realizing the purpose of RGB gray adjustment. The LED driving chips in the LED driving system that are connected in series overcome the defects of overlarge current and overlarge FPC copper foil thickness and the resultant increase of the product cost due to the parallel connection of the prior art. In the invention, the LED driving chips of each node are same in current, the thickness of FPC thickness is significantly lowered, and resultantly the cost of the whole product is saved by 50-60% as well. On the other hand, coincidence of the power transmission path and the data transmission path simplifies wiring of the system and reduces wiring cost of the product as well.

Further, in order to avoid instable operation and frequent restarting of the system when the LED is started in the low voltage, in this embodiment, each of the LED driving chips also comprises a reference voltage generation module 7 and a comparison module 8. Evidently, the reference voltage generation module is used for generating reference voltage, and the comparison module 8 is used for comparing the voltage of the input end of the current LED power supply with the fixed multiple of the reference voltage, so as to make sure whether the current power voltage is in the undervoltage state. The reference voltage output end of the reference voltage generation module 7 is connected with the reference voltage input end of the comparison module 8, the comparison voltage input end of the comparison module 8 is connected with the main input end of the LED driving chips, and the comparison result output end of the comparison module 8 is connected with the controlled end of the power supply module 3 so as to control the power supply module 3 to be on or off. If the current power voltage is smaller than the reference voltage, the LED driving chips are currently under-voltage, and the comparison module 8 outputs a control signal to the controlled end of the power supply module 3 so that the power supply module 3 stops supplying power to the LED driver chips, and the defect of system instability caused when the LED driving chips are started in the undervoltage state is avoided. If the current power voltage is larger than the reference voltage, the LED driving chips are normal, and the comparison module 8 outputs a control signal to the controlled end of the power supply module 3 so that the power supply module 3 starts supplying power to the LED driver chips, and the defect of system instability caused when the LED driving chips. It should be noted that reference voltage generated by the reference voltage generation module 7 can be set as appropriate, and it will not be elaborated herein.

Further, in order to guarantee stability of reference voltage and reduce error of the reference voltage, in this embodiment, each of the LED driving chips also comprises a storage module 9 used for storing calibration value of the reference voltage, and the reference voltage calibration value output end of the storage module 9 is connected with the reference voltage input end of the comparison module 8. Particularly, the storage module 9 is an OTP storage module. On the other hand, the storage module 9 stores the address of the LED driving chip. The logic control module 1 burns an address to the storage module 9, and the address of the LED driving chip is stored in the storage module 9. In this way, each LED driving chip can be provided with an independent address.

Further, in order to make power supply of the LED driving chip more smooth and guarantee the stability of the LED driving chips, each of the LED driving chip also comprises a filter module 11 used for filtering clutter signals of the power supply, and the filter module 11 is arranged between the main input end and the power supply module 3. The filter module 11 filters digital signals on the power transmission path so as to guarantee smoothness of the driving power supply of the LED driving chip and their stability thereby. Further, the power supply filtered by the filter module 11 is used for the entire LED driving chip.

Further, in order to connect more LED driving chips in series in the LED driving system, expand system capacity, in this embodiment, the LED driving system also comprises a relay 10 used for compensating the voltage. The relay 10 is arranged among the serially connected LED driving chips so as to lengthen the serial connection line. Particularly, if the LED driving chips with working voltage of 3.3V are connected on the mains supply of 220V in series, the mains supply of 220V can supply power for 66 LED driving chips. 66 driving chips are considered as one node in the LED driving system. The relay 10 is arranged on the node so as to boost the power of the power output end of the 66th LED driving chip to be 220V in such a way that the LED driving chips of the second node can be connected on smoothly. The relay 10 added in this embodiment effectively expands capacity of the LED driving system.

The foregoing is a further detailed description of the invention in connection with specific embodiments, which cannot be considered as limitations of this invention. It will be apparent to those skilled in the art that a few simple deductions or substitutions can be made without departing from the spirit of the invention.

What is claimed is:

1. An LED driving system with power transmission path coincided with data transmission path, comprising a plurality of LED driving chips, each of which comprises a main input end, a main output end, a logic control module, an RGB gray adjustment module, a power supply module, a voltage clamping module, a digital signal extraction module and a signal processing module. The system is characterized in that each LED driving chip also comprises:
a voltage clamping module used for clamping power supply voltage of the LED driving chips within the preset range;
a digital signal extraction module used for extracting Manchester code containing RGB gray data and outputting corresponding signals;
a signal processing module used for receiving extraction signals and acquiring valid data of the corresponding position according to the addresses stored in the current LED driving chips, and outputting the valid data to the logic control module in such a way that the logic control module can control the RGB gray adjustment module to adjust RGB grayscale according to the valid data.
Among them, the input end of the voltage clamping module is connected with the main output end of the previous LED driving chip through the main input end, and the output end is connected with the main input end of the next LED driving chip through the main output end; the power supply module is connected with the main input end of the LED driving chip and supplies power for it; the input end of the digital signal extraction module is connected with the main input end of the LED driving chip, and the output end thereof is connected with the input end of the signal processing module; the output end of the signal processing module is connected with the input end of the logic control module; the output end of the logic control module is connected with the controlled end of the RGB gray adjustment module.

2. The LED driving system with power transmission path coincided with data transmission path according to claim 1, characterized in that each of the LED driving chip also comprises a reference voltage generation module used for generating reference voltage, and a comparison module, wherein the reference voltage output end of the reference voltage generation module is connected with the reference voltage input end of the comparison module, the comparison voltage input end of the comparison module is connected with the main input end of the LED driving chips, and the comparison result output end of the comparison module is connected with the controlled end of the power supply module so as to control the power supply module to be on or off.

3. The LED driving system with power transmission path coincided with data transmission path according to claim 2, wherein each of the LED driving chips also comprises a storage module used for storing calibration value of the reference voltage and the addresses of the LED driving chips, and the reference voltage calibration value output end of the storage module is connected with the reference voltage input end of the comparison module.

4. The LED driving system with power transmission path coincided with data transmission path according to claim 1, wherein each of the LED driving chips also comprises a filter module used for filtering digital signals, and the filter module is arranged between the main input end and the power supply module.

5. The LED driving system with power transmission path coincided with data transmission path according to claim 1, wherein the LED driving system also comprises a relay used for compensating voltage, and the relay is arranged among the serially connected LED driving chips so as to lengthen the serial connection line.

6. The LED driving system with power transmission path coincided with data transmission path according to claim 2, wherein the LED driving system also comprises a relay used for compensating voltage, and the relay is arranged among the serially connected LED driving chips so as to lengthen the serial connection line.

7. The LED driving system with power transmission path coincided with data transmission path according to claim 3, wherein the LED driving system also comprises a relay used for compensating voltage, and the relay is arranged among the serially connected LED driving chips so as to lengthen the serial connection line.

8. The LED driving system with power transmission path coincided with data transmission path according to claim 4, wherein the LED driving system also comprises a relay used for compensating voltage, and the relay is arranged among the serially connected LED driving chips so as to lengthen the serial connection line.
